(19) United States
(12) Patent Application Publication
(10) Pub. No.: US 2024/0402923 A1
(43) Pub. Date: Dec. 5, 2024

(54) SPARE MEMORY MANAGEMENT IN DATA STORAGE DEVICE

(71) Applicant: QUALCOMM Incorporated, San Diego, CA (US)

(72) Inventors: Santhosh Reddy AKAVARAM, Hyderabad (IN); Prakhar SRIVASTAVA, Lucknow (IN); Sridhar ANUMALA, Hyderabad (IN); Hung VUONG, Coronado, CA (US); Sonali JABREVA, Firozabad (IN); Khushboo KUMARI, Hyderabad (IN)

(21) Appl. No.: 18/327,691

(22) Filed: Jun. 1, 2023

(51) Int. Cl. G06F 3/06

(52) U.S. Cl. CPC G06F 3/0631; G06F 3/0604; G06F 3/0653; G06F 3/0679

(57) ABSTRACT

Aspects of the present disclosure are directed to techniques and procedures for storing data in a data storage device that uses nonvolatile memory (NVM) to store data. The NVM can be organized into logical units that are assigned respective logical unit numbers. The data storage device can report to a host the amount of spare blocks needed for one or more logical units (LUs), and then the host can relinquish some memory blocks to be reallocated as spare blocks. The data storage device can implement a spare block resource management policy per LU and allocate a predetermined amount of spare blocks per LU. The data storage device can implement a spare block resource management policy per memory type and allocate a predetermined amount of spare blocks for LUs with the same memory type.

### TECHNICAL FIELD

The technology discussed below relates generally to a data storage device, and more particularly, to techniques for managing spare memory of a data storage device.

### INTRODUCTION

A data storage device may use volatile memories and/or nonvolatile memories for storing data. A volatile memory cannot retain data stored therein at power-off, but a nonvolatile memory can retain data stored therein at power-off. Some examples of volatile memories include static random access memory (SRAM), dynamic RAM (DRAM), and synchronous DRAM (SDRAM). Some examples of nonvolatile memories include a read-only memory (ROM), a programmable ROM (PROM), an electrically programmable ROM (EPROM), an electrically erasable and programmable ROM (EEPROM), a flash memory device, a phase-change RAM (PRAM), a magnetic RAM (MRAM), a resistive RAM (RRAM), and a ferroelectric RAM (FRAM).

The flash memory device is widely used as a storage device in various devices, for example, computing devices, mobile devices, and wireless communication devices to store large quantities of data. In some aspects, a flash memory-based storage device can be implemented as a universal flash storage (UFS) defined by the JEDEC (Joint Electron Device Engineering Council) standard. The physical storage space of the data storage device can be divided into logical units and assigned respective logical unit numbers. A logical unit number (LUN) is a unique identifier assigned to a logical unit (LU), which represents a portion of the physical storage space. In the context of UFS, a LUN can refer to a specific partition or virtual storage unit within a UFS device.

Flash memory devices (e.g., UFS devices) have a limited lifespan, and their individual memory blocks can wear out over time as they are repeatedly written and erased. A flash memory device may include one or more spare blocks that can be used to replace failed or defective memory blocks in the flash memory device. Spare blocks provide a way to prolong the lifespan of the flash memory device and ensure that it continues to function reliably even in the face of block failures.

### BRIEF SUMMARY

The following presents a summary of one or more implementations in order to provide a basic understanding of such implementations. This summary is not an extensive overview of all contemplated implementations and is intended to neither identify key or critical elements of all implementations nor delineate the scope of any or all implementations. Its sole purpose is to present some concepts of one or more implementations in a form as a prelude to the more detailed description that is presented later.

One aspect of the disclosure provides a data storage device. The data storage device includes: a nonvolatile memory comprising a plurality of logical units (LUs) and a plurality of spare blocks (SBs), each of the plurality of LUs being allocated with one or more of the plurality of SBs; and a memory controller connected to the nonvolatile memory. The memory controller is configured to: determine usage information of at least a first logical unit and a second logical unit of the plurality of LUs; and allocate, based on the usage information, a first spare block of the plurality of SBs associated with the first logical unit to the second logical unit in response to a depletion of the one or more of the plurality of SBs allocated to the second logical unit.

One aspect of the disclosure provides a method of operating a data storage device. The method includes determining usage information of at least a first logical unit and a second logical unit of a plurality of logical units (LUs), each of the plurality of LUs being allocated with one or more of a plurality of spare blocks (SBs). The method further includes allocating, based on the usage information, a first spare block of the plurality of SBs associated with the first logical unit to the second logical unit in response to a depletion of the one or more of the plurality of SBs allocated to the second logical unit.

One aspect of the disclosure provides a data storage device. The data storage device includes: means for storing data in a nonvolatile memory comprising a plurality of logical units (LUs) and a plurality of spare blocks (SBs), each of the plurality of LUs being allocated with one or more of the plurality of SBs; means for determining usage information of at least a first logical unit and a second logical unit of the plurality of LUs; and means for allocating, based on the usage information, a first spare block of the plurality of SBs associated with the first logical unit to the second logical unit in response to a depletion of the one or more of the plurality of SBs allocated to the second logical unit.

One aspect of the disclosure provides a data storage system. The data storage system includes: a host; and a data storage device connected to the host. The data storage device includes: a nonvolatile memory comprising a plurality of logical units (LUs) and a plurality of spare blocks (SBs), each of the plurality of LUs being allocated with one or more of the plurality of SBs; and a memory controller connected to the nonvolatile memory. The memory controller is configured to: store data from the host in the nonvolatile memory; determine usage information of at least a first logical unit and a second logical unit of the plurality of LUs; and allocate, based on the usage information, a first spare block of the plurality of SBs associated with the first logical unit to the second logical unit in response to a depletion of the one or more of the plurality of SBs allocated to the second logical unit.

To the accomplishment of the foregoing and related ends, the one or more implementations include the features hereinafter fully described and particularly pointed out in the claims. The following description and the annexed drawings set forth in detail certain illustrative aspects of the one or more implementations. These aspects are indicative, however, of but a few of the various ways in which the principles of various implementations may be employed and the described implementations are intended to include all such aspects and their equivalents.

### BRIEF DESCRIPTION OF THE DRAWINGS

FIG. 1 is a block diagram illustrating a data storage system according to some aspects of the present disclosure.

FIG. 2 is a block diagram illustrating a first spare block management scheme according to some aspects of the present disclosure.

FIG. 3 is a block diagram illustrating a second spare block management scheme according to some aspects of the present disclosure.

FIG. 4 illustrates a table of memory utilization and memory availability of a plurality of logical units according to some aspects of the present disclosure.

FIG. 5 is a flow chart illustrating a process of determining a reallocation factor for a logical unit based on memory availability and memory utilization according to some aspects of the present disclosure.

FIG. 6 is a flow chart illustrating a process of adjusting the priority of logical units according to some aspects of the present disclosure.

FIG. 7 is a flow chart illustrating a process of selecting a logical unit for spare block reallocation according to some aspects of the present disclosure.

FIG. 8 illustrates a sorted table of memory utilization and memory availability of a plurality of logical units according to some aspects of the present disclosure.

FIG. 9 is a flow chart illustrating a method for reallocating spare block in a data storage device according to some aspects of the present disclosure.

FIG. 10 is flow diagram illustrating a method for requesting a host to release memory for reallocation in a data storage device according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, these concepts may be practiced without these specific details. In some instances, well-known structures and components are shown in block diagram form in order to avoid obscuring such concepts.

The terminology used herein is for the purpose of describing particular examples only and is not intended to be limiting. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, processes, operations, elements, and/or components, but do not preclude the presence or addition of one or more other features, integers, processes, operations, elements, components, and/or groups thereof.

Further, many examples are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects may be embodied in a number of different forms, all of which have been contemplated to be within the scope of the claimed subject matter. In addition, for each of the examples described herein, the corresponding form of any such examples may be described herein as, for example, “logic configured to” perform the described action.

Some aspects of the disclosure provide a data storage device that uses nonvolatile memory (NVM) to store data. An example of nonvolatile memory is flash memory (e.g., NAND-based flash memory). In one example, the data storage device can be implemented as a Universal Flash Storage (UFS) device or any data storage device that uses flash memory as the main storage. The main storage can be organized into logical units that are assigned respective logical unit numbers. A logical unit number (LUN) is a unique identifier assigned to a logical unit (LU), which represents a portion of the physical storage space of the main storage. For example, a LUN can refer to a specific partition or virtual storage unit within the data storage device.

The data storage device may include one or more spare blocks (e.g., reserved memory blocks) that can be used to replace failed or defective memory blocks in the main storage. As the data storage device ages and reaches its designed end of life, more and more memory blocks can fail. The data storage device can maintain its specified storage capacity (e.g., exported capacity) by using spare blocks to replace the failed memory blocks. Furthermore, the spare blocks can be used for various housekeeping operations, for example, wear leveling, defragmentation, etc. However, when all provisioned spare blocks are consumed, the data storage device can no longer provide its specified storage capacity when more memory blocks fail. In some examples, the data storage device may stop being functional (e.g., stop responding to read and write accesses) or become partially functional (e.g., become read-only).

In some aspects, a data storage device can continue to be operable and fully functional when the device gets close to the device's designed lifetime by dynamically changing the storage capacity of the device. For example, the data storage device can reduce its reported capacity such that some memory blocks can be reallocated or repurposed as spare blocks to compensate for aging or failing memory blocks. In some aspects, the data storage device can report to a host the amount of spare blocks needed for one or more LUs, and then the host can relinquish some memory blocks to be reallocated as spare blocks. In some aspects, the data storage device may implement a spare block resource management policy per LU and allocate a predetermined amount of spare blocks per LU. In some aspects, the data storage device may implement a spare block resource management policy per memory type and allocate a predetermined amount of spare blocks for LUs with the same memory type.

In some aspects, the number of blocks released from each LU or from LUs with the same memory type can be determined based on the memory utilization and memory availability of the LUs. For example, the LUs of the data storage device can have different utilization levels. One or more LUs can have higher utilization than other LUs. If the data storage device randomly releases memory blocks from any LUs when needed, the performance of the data storage device can be affected or degraded, for example, if the data storage device releases blocks from highly utilized LUs instead of releasing blocks from less utilized LUs. In some examples, some LUs can have lower memory availability (e.g., less unused memory) than other LUs. In this case, releasing memory blocks from LUs with lower availability instead of LUs with higher availability can lead to performance degradation. Aspects of the present disclosure provide various techniques, apparatuses, and methods that improve the utilization of spare blocks of a data storage device.

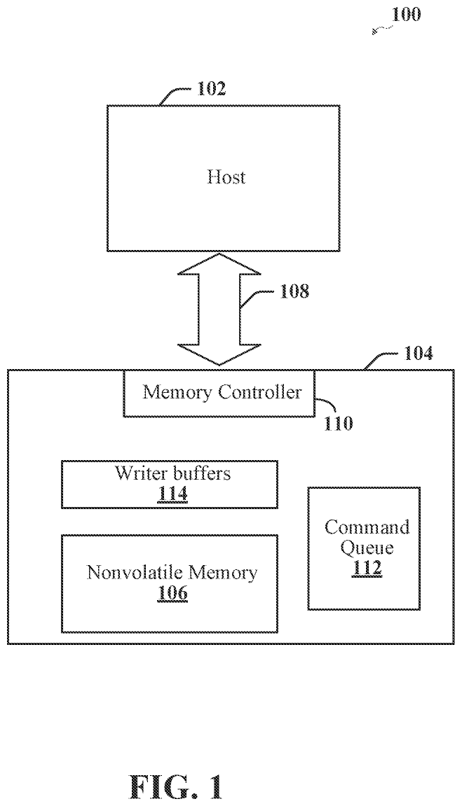

FIG. 1 is a block diagram illustrating a data storage system 100 according to some aspects of the disclosure. A data storage system 100 may include a host 102 and a data storage device 104. In some examples, the data storage system 100 may be implemented in a portable computer, a tablet, a smartphone, a wearable device, a wireless communication device, a base station, a network entity, etc. In some aspects, the host 102 may be a processor such as a central processing unit (CPU), a graphical processing unit (GPU), a digital signal processor (DSP): a controller, a microcontroller, an application processor (AP), a neural processing unit (NPU), a field-programmable gate array (FPGA), etc.

The host 102 can use the data storage device 104 to store data for various operations. In some aspects, the storage device 104 may store data using nonvolatile memory 106 (e.g., NAND flash memory). In some aspects, the data storage device 104 can be compliant with the Universal Flash Storage (UFS) specification defined by JEDEC (Joint Electron Device Engineering Council). In one example, the host 102 (e.g., UFS host) can write data to and read data from the storage device 104 using a storage interface 108 (e.g., UFS interface). In some examples, the storage interface 108 can be implemented using various interface standards, for example, Peripheral Component Interconnect Express (PCIe), Serial Advanced Technology Attachment (ATA), etc. The host 102 can send a write command (with write data) to the storage device 104 in order to store the data in the storage device 104. To read data from the storage device 104, the host 102 can send a read command to the storage device 104 and receive data from the storage device 104. In one example, the host 102 and the storage device 104 can exchange information in the form of Universal Flash Storage Protocol Information Units (UPIUs). A UPIU can include various information transferred via the interface (e.g., interface 108) between the host 102 and the storage device 104. For example, the UPIU can include commands, data read from or written to the storage device 104, status information, and/or control information. For example, the status information in the UPIU can provide information about the status of the storage device 104 or the progress of a particular operation (e.g., write data to or read data from the storage device 104). The status information can provide details about whether an operation was successful, whether an error occurred, and what type of error occurred. The control information in the UPIU can be used to manage the communication between the storage device 104 (e.g., a UFS device) and the host 102. For example, the control information can include information about the device's configuration, power management, and other parameters related to data transfer between the host and the data storage device.

In some aspects, the data storage device 104 may include a memory controller 110 for controlling various operations of the nonvolatile memory 106. In one example, the memory controller 110 may be a Flash memory controller. The memory controller 110 can manage the data flow between the nonvolatile memory 106 and the host 102. In some aspects, the memory controller 110 may include a host controller interface (HCI) for communicating with the host 102 via the storage interface 108. In some aspects, the HCI may be a separate entity from the memory controller 110. In some aspects, the memory controller 110 is responsible for performing various tasks such as error correction, wear leveling, garbage collection, power management, etc. For example, the memory controller 110 may write data to or read data from the nonvolatile memory 106 (e.g., NAND Flash) in response to a command (e.g., a UFS read or write command) received from the host 102 via the storage interface 108. In some aspects, the memory controller 110 may be implemented using a processor such as a microprocessor, a microcontroller, an FPGA, etc. In some aspects, the memory controller 110 can be implemented using a combination of hardware and software to manage the transfer of data between the host 102 and the nonvolatile memory 106. For example, the memory controller 110 can include memory buffers, data converters, and interfaces for communication with the host 102 and the nonvolatile memory 106.

In one example, when the memory controller 110 receives a write command and write data from the host 102, the memory controller 110 can store the received data in the nonvolatile memory 106 according to the write command. In one example, when the memory controller 110 receives a read command from the host 102, the memory controller 110 can read data stored in the nonvolatile memory 106 according to the read command. Then, the memory controller 110 can provide the read data to the host 102, for example, via the interface 108. The data storage device 104 may include a command queue 112 that stores the commands (e.g., write commands and read commands) and data received from the host 102. The command queue 112 can help improve the performance of the storage device 104 by allowing it to process multiple commands simultaneously and/or optimize the order in which the commands are executed.

In some aspects, the data storage device 104 may include a write buffer 114 or write cache to support a boosted write function (e.g., a turbo write) to increase write speed or throughput of the storage device 104. For example, the host 102 can send commands to the memory controller 110 via the interface 108 to enable or disable the boosted write function. When the boosted write function is enabled, the storage device 104 can perform a boosted write operation to write data to the nonvolatile memory 106 at a write speed higher than that when the boosted write function is not used (i.e., a normal or non-boosted write function is used). In some aspects, the boosted write function may be performed using the write buffers 114 that can provide improved performance (e.g., improved write speed or throughout) than writing data directed to a main storage of the nonvolatile memory 106. The boosted write operation will be more fully described below with reference to the drawings.

In some aspects, the write buffers 114 can be a portion of the nonvolatile memory 106 configured as single-level cell (SLC) memory cells. Each SLC memory cell can store one bit of information. In some aspects, the nonvolatile memory 106 can provide a multi-level cell (MLC) portion or a triple-level cell (TLC) portion to implement the main storage. In the MLC portion, each memory cell can store two bits of information. In the TLC portion, each memory cell can store three bits of information. In other aspects, it is contemplated that the nonvolatile memory 106 can support other configurations that allow more than 3 bits of information per cell. The SLC portion (write buffers) has a higher data write speed and/or throughput than that of the MLC/TLC portion (main storage).

In some aspects, the storage device 104 may further include any other storage space, for example, a cache memory, a reserved area, a meta area for storing meta data, in addition to write buffers, a command queue, and the nonvolatile memory illustrated in FIG. 1. However, for convenience of description, additional description associated with the other storage space will be omitted (or minimized), and the below description will be focused on the nonvolatile memory where user data are stored.

In some aspects, a data storage device (e.g., data storage device 104 of FIG. 1) can implement a spare memory resource management scheme per logical unit (LU), and allocate a fixed number of spare blocks per logical unit. In some aspects, the data storage device can implement a spare memory resource management scheme per memory type, and allocate a fixed number of spare blocks for LUs with the same memory type (e.g., SLC, MLC. TLC, etc.).

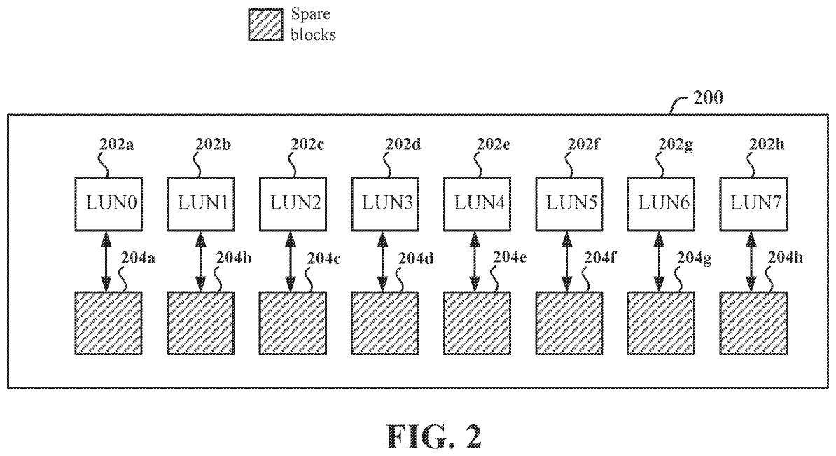

FIG. 2 illustrates a first spare block management scheme for allocating spare blocks per LU according to some aspects of the disclosure. In one aspect, a data storage device may configure a nonvolatile memory 200 into a plurality of LUs (eight exemplary LUs 202a, 202b, 202c, 202d, 202e, 202f, 202g, 202h are shown in FIG. 2) that can be identified with respective LUNs (e.g., LUN0, LUN1, LUN2, LUN3, LUN4, LUN5, LUN6, and LUN7). Each LU may correspond to one or more physical memory blocks of the nonvolatile memory 200. In one example, the nonvolatile memory 200 may be the nonvolatile memory 106 of FIG. 1 (e.g., NAND flash). Some memory blocks of the nonvolatile memory 200 can be reserved (or over-provisioned) as spare blocks (e.g., exemplary spare blocks 204a, 204b, 204c, 204d, 204c, 204f, 204g, and 204h shown in FIG. 2). In some aspects, the data storage device (e.g., data storage device 104) can allocate a certain number of spare blocks to each LU. In some aspects, the spare blocks can be dynamically allocated among the LUs as needed, providing a mechanism for the automatic replacement of defective or worn-out blocks such that any impact on the performance or storage capacity of the data storage device can be avoided or reduced. As data is written to the LUs, the data storage device can monitor the usage of the memory blocks of each LU. For example, the data storage device can keep track of the number of write cycles that have been performed on each memory block. When the data storage device determines that a memory block has exceeded a predetermined write cycle limit and/or has become defective due to other errors, the data storage device can replace the bad block with a spare block. For example, the data storage device can remap the logical address of the bad block to the spare block. Then, the data from the bad block can be moved to the spare block.

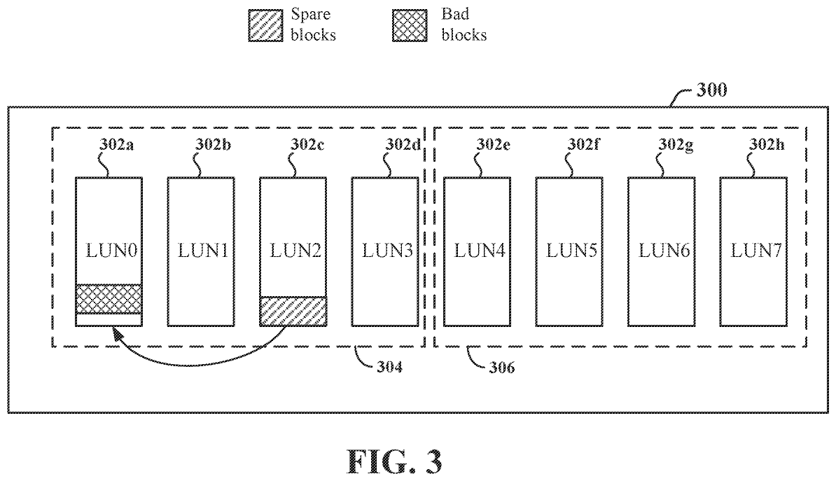

FIG. 3 illustrates a second spare memory block management scheme according to some aspects of the disclosure. In one aspect, a data storage device may configure a nonvolatile memory 300 into a plurality of LUs (eight exemplary LUs 302a, 302b, 302c, 302d, 302e, 302f, 302g, 302h are shown in FIG. 3) that are assigned respective LUNs (e.g., LUN0, LUN1, LUN2, LUN3, LUN4, LUN5, LUN6, LUN7). Each LU may correspond to one or more physical memory blocks of the nonvolatile memory 300. In one example, the nonvolatile memory 300 may be the nonvolatile memory 106 of FIG. 1. As data is written to the LUs, the data storage device can monitor the usage of the memory blocks of each LU. For example, the data storage device can keep track of the number of write cycles that have been performed on each memory block. When the data storage device determines that a memory block of a first LU (e.g., LU 302a) has exceeded a predetermined write cycle limit and/or has become defective due to other errors, the data storage device can reallocate memory block(s) from a second LU (e.g., LU 302c) as spare blocks to replace the bad/failing block of the first LU. To that end, the data storage device (e.g., memory controller 110) can send a request to a host (e.g., host 102) to release some blocks from the second LU such that the released blocks can be reallocated to the first LU as spare blocks. For example, the host can remap the logical address of the released blocks as spare blocks of the first LUN.

In some aspects, the memory blocks can be dynamically reallocated between LUs of the same memory type. For example, LU 302a, LU 302b, LU 302c, and LU 302d may be a first memory type, and LU 302e, LU 302f, LU 302g, and LU 302h may be a second memory type that is different from the first memory type. Some examples of memory types are Single-Level Cell (SLC), Multi-Level Cell (MLC), and Triple-Level Cell (TLC). SLC memory can store one bit of data per cell, MLC memory can store two bits of data per cell, and TLC can store three bits of data per cell. SLC flash has the highest endurance of the three. SLC also has the fastest read and write speeds of the three, followed by MLC and then TLC.

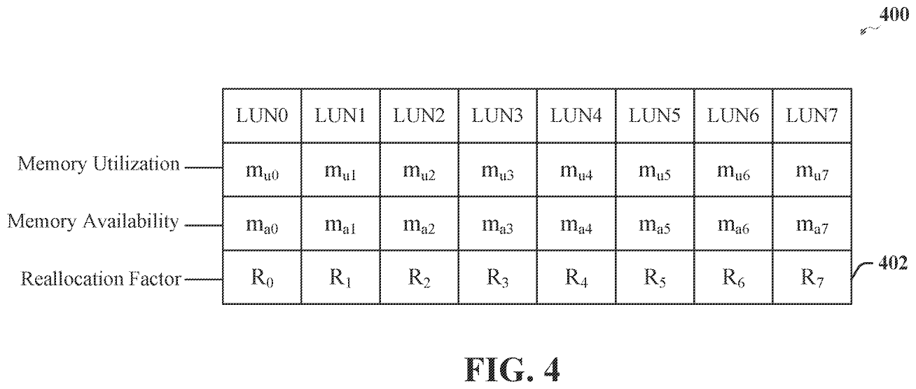

In some aspects, the data storage device can determine the number of memory blocks to be reallocated dynamically among a plurality of LUs based on memory usage information, for example, memory utilization and memory availability of the LUs. In some examples, the data storage device can maintain the memory usage information in a table, dataset, database, data store, etc. FIG. 4 is a memory allocation table 400 illustrating exemplary memory utilization, memory availability, and reallocation factors of a plurality of LUs. For example, the LUs can be assigned with respective logical unit numbers LUN0, LUN1, LUN2, LUN3, LUN4, LUN5, LUN6, and LUN7. In some aspects, the number of spare memory blocks removed from a resource pool (e.g., memory blocks from one or more LUs) can be decided based on both memory utilization and memory availability of the LUs. To that end, the data storage device can determine the memory utilization (mᵤ) and memory availability (mₐ) of each LU included in the resource pool. For example, table 400 illustrates the memory utilization (mᵤ₀, mᵤ₁, mᵤ₂, mᵤ₃, mᵤ₄, mᵤ₅, mᵤ₆, mᵤ₇) and memory availability mₐ₀, mₐ₁, mₐ₂, mₐ₃, mₐ₄, mₐ₅, mₐ₆, mₐ₇ of a number of LUs (identified as LUN 0 to LUN 7). In some aspects, some LUs of a data storage device may not be included in the resource pool for spare block management. For example, a LU of a boot partition or write-protected partition is not included in the resource pool for dynamic reallocation of spare blocks among LUs. The reallocation factor (Rᵢ) can be determined based on the memory utilization and memory availability.

In some aspects, the memory utilization (mᵤ) can be determined based on the write operation frequency and/or the speed of filling up of a LU. In one aspect, the memory controller 110 (FIG. 1) can keep track of the mᵤ of the LUs in table 400. A LU with a higher mᵤ is written more frequently and/or has less available space than a LU with a lower mᵤ. The data storage device can use any suitable range of values to represent the mᵤ of each LU (e.g., the value of 1 being the lowest utilization and the value of 100 being the highest utilization).

In some aspects, the memory availability (mₐ) can indicate the available memory for each LU. In one aspect, the memory controller 110 can track the mₐ of the LUs in table 400. A LU with a higher mₐ has more available or spare memory (i.e., memory block not used to store data) than a LU with a lower mₐ. In one example, the mₐ may indicate the amount of available memory in bytes or the like. In one example, the data storage device can use any suitable range of values to represent the mₐ of each LU (e.g., the value of 1 being the lowest and the value of 100 being the highest).

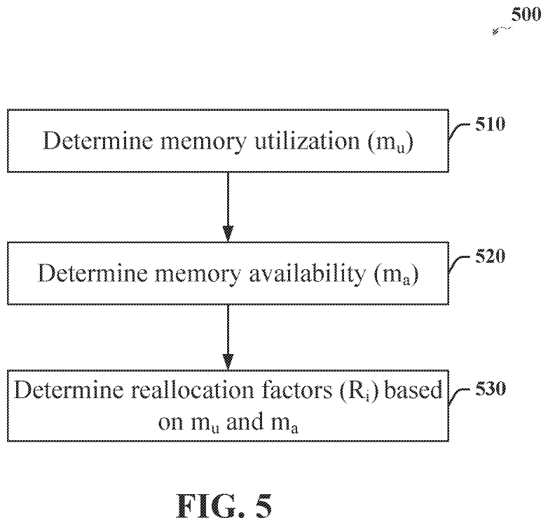

FIG. 5 is a flow chart illustrating a process 500 of determining a reallocation factor for each LU based on the memory availability and memory utilization according to some aspects of the disclosure. At 510, the data storage device (e.g., memory controller 110) can determine the memory utilization (mᵤ) of each LU. At 520, the data storage device can determine the memory availability (mₐ) of each LU. At 530, the data storage device can determine the reallocation factor (Rᵢ) for each LU. In some aspects, mᵤ and mₐ can be determined for each LU in any order or concurrently. In some aspects, the data storage device (e.g., memory controller 110) can determine the reallocation factor (Rᵢ) for each LUᵢ as follows:

$${R}_{i} = W 1 {m}_{ai} - W 2 {m}_{ui} \qquad ( 1 )$$

In equation (1), the parameters W1 and W2 are configurable weights, mₐᵢ is the memory availability of LUᵢ, and mᵤᵢ is the memory utilization of LUᵢ. A greater W1 gives more weight to mₐ and a smaller W1 gives less weight to mₐ in equation 1. A greater W2 gives less weight to mᵤ and a smaller W2 gives more weight to mᵤ in equation 1. The data storage device gives higher priority to a LU with a higher Rᵢ when the data storage device chooses a LU to reallocate its spare blocks among the LUs included in the resource pool.

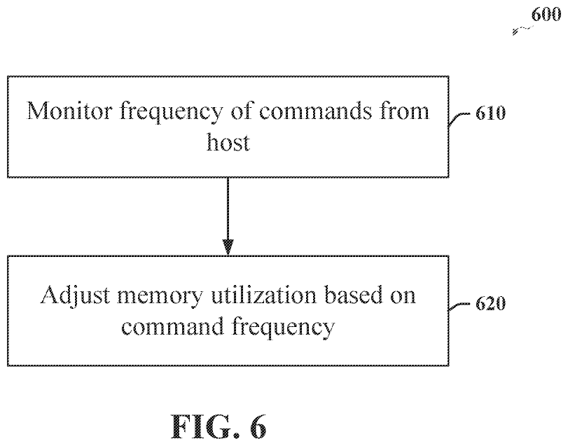

FIG. 6 is a flow chart illustrating a process 600 of adjusting the mᵤ of LUs based on command frequency according to some aspects of the disclosure. At 610, the data storage device (e.g., memory controller 110 or HCI) can monitor the frequency of incoming commands (e.g., from host 102 of FIG. 1) for each LU. For example, the data storage device can monitor the commands for each LU included in a spare block resource management scheme as described above in relation to FIGS. 3-5. A higher command frequency can indicate higher utilization and/or command throughput of a LU, and a lower command frequency can indicate lower utilization and/or command throughput of a LU. At 620, the data storage device can adjust the memory utilization mᵤ of the LUs based on the respective command frequencies. For example, the data storage device can increase the mᵤ of a LU with high command frequency and decrease the mᵤ of a LU with lower command frequency.

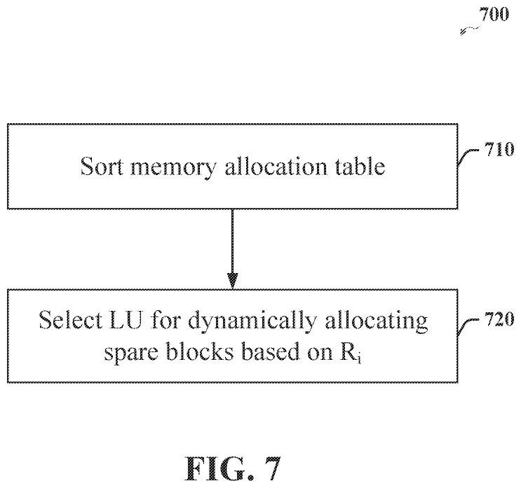

FIG. 7 is a flow chart illustrating a process 700 of selecting a LU for reallocation of spare blocks in a data storage device according to some aspects of the disclosure. At 710, the data storage device (e.g., memory controller 110) can sort the table 400 based on the reallocation factors Rᵢ. The data storage device can sort the table 400 in decreasing or increasing values of Rᵢ. In one example, the data storage device can compare the values in the reallocation factor row 402 of the table 400 and then rearrange the LUN columns accordingly based on the increasing or decreasing values of the Rᵢ. At 720, the data storage device can select the LU with the maximum Rᵢ for reallocating one or more of its memory blocks (e.g., as spare blocks) to another LU that has exhausted its spare block allocation. According to equation (1), a LU with a greater Rᵢ can have greater memory availability and/or less memory utilization than other LUs. In some aspects, the data storage device can select the LU without sorting the table.

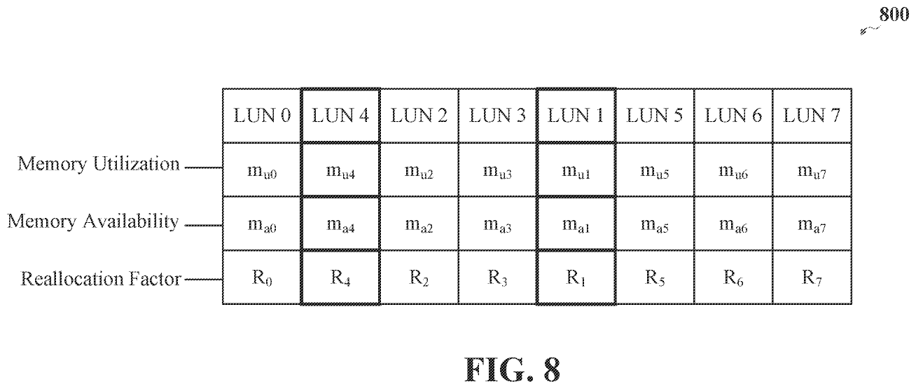

FIG. 8 illustrates a sorted table 800 of memory utilization and memory availability of a plurality of logical units according to some aspects of the present disclosure. The table 800 may be the same as table 400 after being sorted according to the values of Rᵢ. In table 800, the position of the LUN1 and LUN4 columns are swapped after sorting. In other examples, the LUN columns have other orders after sorting based on Rᵢ.

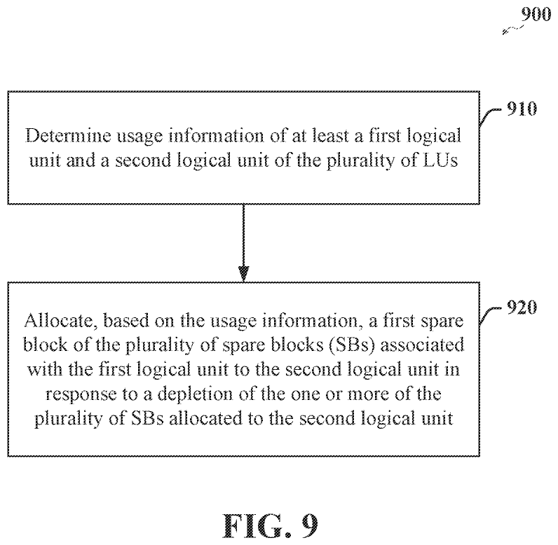

FIG. 9 illustrates a flow chart of a method 900 for reallocating spare memory blocks in a data storage device according to some aspects of the present disclosure. In one example, the method 900 can be performed using the data storage system 100 of FIG. 1. For example, the method 900 can increase the memory utilization efficiency of a data storage device 104 by reallocating memory from a less utilized LU to another LU that has exhausted its spare block allocation. In other aspects, the method may be adapted to suit other data storage devices.

In some aspects, the data storage device includes nonvolatile memory (e.g., nonvolatile memory 106 of FIG. 1) including a plurality of logical units (LUs) and a plurality of spare blocks (SBs). Each LU may be allocated a predetermined amount of SBs. Each LU can use the allocated SB to replace a failed memory block when the LU depleted its original SB allocation.

At 910, the data storage device can determine usage information of at least a first logical unit (LU) and a second logical unit (LU) of the plurality of LUs. In one example, the memory controller 110 can provide a means to determine the usage information of the plurality of LUs. In one example, the usage information may include the memory utilization (e.g., mᵤ) and memory availability (e.g., mₐ) of each LU as described above in relation to FIGS. 4-8. In some aspects, the data storage device can determine a reallocation factor (Rᵢ) for each LU based on the memory utilization and the memory availability.

At 920, the data storage device can allocate, based on the usage information, a first spare block of the plurality of SBs associated with the first LU to the second LU in response to a depletion of the one or more of the plurality of SBs associated with the second logical unit. For example, the second LU depleted its associated SBs when the second LU used up all associated SBs to replace one or more failed memory blocks of the second LU. In one example, the memory controller 110 can provide a means to reallocate the spare blocks among the LUs. In some aspects, the data storage device can select, based on the reallocation factor, the first spare block to be reallocated to the second logical unit.

In some aspects, the reallocation factor of the first logical unit can be greater than the reallocation factors of other LUs. The data storage device can reallocate one or more blocks of the SBs from less utilized LU(s) to highly used LU(s) based on their usage information (e.g., reallocation factor, memory utilization, and/or memory availability). In some aspects, the data storage device can monitor the available memory block in each LU and reallocate memory blocks from LUs with more available memory to highly used LUS when a LU has exhausted its allocated spare blocks.

In some aspects, some of the above-described methods and processes may be performed by a host (e.g., host 102 of FIG. 1) to monitor the memory utilization efficiency of the data storage device. Based on the memory utilization efficiency, the host can instruct the data storage device to allocate a first spare block of the plurality of SBs associated with the first LU to the second LU, for example, in response to a depletion of the one or more of the plurality of SBs associated with the second logical unit.

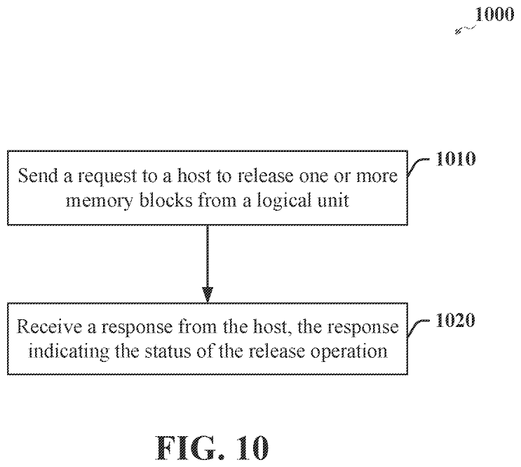

FIG. 10 is a flow diagram illustrating a method 1000 for requesting a host to release memory for reallocation in a data storage device according to some aspects of the present disclosure. In one example, the method 1000 can be performed using the data storage system 100 of FIG. 1. In other aspects, the method 1000 may be adapted to suit other data storage devices.

At 1010, a data storage device can send a request to a host to release one or more memory blocks from a logical unit. In one aspect, the memory controller 110 can provide a means to send the request to the host. In one example, the memory controller 110 (e.g., a HCI included in the controller) can send the request in a Universal Flash Storage Protocol Information Unit (UPIU) or any data packet via the interface 108. The header of the UPIU can contain information that indicates the type of the UPIU, for example, a Release Memory Command (RMC). The UPIU can contain the logical unit number (LUN) of the logical unit whose memory is to be released, the amount of memory to be released, and the reason for the release.

At 1020, the data storage device can receive a response from the host. In one aspect, the data storage device can use the memory controller 110 to receive the response. In one example, the host can respond with a UPIU that contains the status of the release operation, such as whether the release was successful or not. If the response (e.g., confirmation) indicates that the request is successful, the data storage device can reallocate the memory blocks to another logical unit that has exhausted a spare block allocation.

The following provides an overview of examples of the present disclosure.
A first aspect of the disclosure provides a data storage device. The data storage device comprises: a nonvolatile memory comprising a plurality of logical units (LUs) and a plurality of spare blocks (SBs), each of the plurality of LUs being allocated with one or more of the plurality of SBs; and a memory controller. The memory controller is configured to: determine usage information of at least a first logical unit and a second logical unit of the plurality of LUs; and allocate, based on the usage information, a first spare block of the plurality of SBs associated with the first logical unit to the second logical unit in response to a depletion of the one or more of the plurality of SBs allocated to the second logical unit.
A second aspect of the disclosure, alone or in combination with the first aspect, wherein the usage information comprises memory utilization of the plurality of LUs and memory availability of the plurality of LUs.
A third aspect of the disclosure, alone or in combination with the second aspect, wherein the memory controller is further configured to: determine the memory utilization based on at least one of a write operation frequency or a speed of filling up of each LU of the plurality of LUs; and determine the memory availability based on an available amount of memory of each LU of the plurality of LUs.
A fourth aspect of the disclosure, alone or in combination with any of the second and third aspects, wherein the memory controller is further configured to: determine a reallocation factor for each of the plurality of LUs, based on the memory utilization and the memory availability; and select, based on the reallocation factor, the first spare block to be reallocated from the first logical unit to the second logical unit as a spare block.
A fifth aspect of the disclosure, alone or in combination with the fourth aspect, wherein the reallocation factor of the first logical unit is greater than the reallocation factor of at least one other LU of the plurality of LUs.
A sixth aspect of the disclosure, alone or in combination with any of the first, second, and third aspects, wherein the memory controller is further configured to determine that the first logical unit is less utilized among the plurality of LUs based on the usage information.
A seventh aspect of the disclosure, alone or in combination with any of the first, second, and third aspects, wherein the memory controller is further configured to: monitor available memory in each LU of the plurality of LUs; and reallocate a spare block of the plurality of SBs from the first logical unit to the second logical unit, the first logical unit having more available memory among the plurality of LUs.
An eighth aspect of the disclosure, alone or in combination with any of the first, second, and third aspects, wherein the memory controller is further configured to: send a request to a host to release the first spare block associated with the first logical unit; and receive a confirmation from the host, indicating the release of the first spare block.
A ninth aspect of the disclosure provides a method of operating a data storage device. The method comprises: determining usage information of at least a first logical unit and a second logical unit of a plurality of logical units (LUs), each of the plurality of LUs being allocated with one or more of a plurality of spare blocks (SBs); and allocating, based on the usage information, a first spare block of the plurality of SBs associated with the first logical unit to the second logical unit in response to a depletion of the one or more of the plurality of SBs allocated to the second logical unit.
A tenth aspect of the disclosure, alone or in combination with the ninth aspect, wherein the usage information comprises: memory utilization of the plurality of LUs; and memory availability of the plurality of LUs.
An eleventh aspect of the disclosure, alone or in combination with the tenth aspect, the method further comprises: determining the memory utilization based on at least one of a write operation frequency or a speed of filling up of each LU of the plurality of LUs; and determining the memory availability based on an available amount of memory of each LU of the plurality of LUS.
A twelfth aspect of the disclosure, alone or in combination with any of the tenth and eleventh aspects, the method further comprises: determining a reallocation factor for each of the plurality of LUs, based on the memory utilization and the memory availability; and selecting, based on the reallocation factor, the first spare block to be reallocated from the first logical unit to the second logical unit as a spare block.
A thirteenth aspect of the disclosure, alone or in combination with the twelfth aspect, wherein the reallocation factor of the first logical unit is greater than the reallocation factor of at least one other LU of the plurality of LUs.
A fourteenth aspect of the disclosure, alone or in combination with any of the ninth, tenth, and eleventh aspects, the method further comprises determining that the first logical unit is less utilized among the plurality of LUs based on the usage information.
A fifteenth aspect of the disclosure, alone or in combination with any of the ninth, tenth, and eleventh aspects, the method further comprises: monitoring available memory in each LU of the plurality of LUs; and reallocating a spare block of the plurality of SBs from the first logical unit to the second logical unit, the first logical unit having more available memory among the plurality of LUs.
A sixteenth aspect of the disclosure, alone or in combination with any of the ninth, tenth, and eleventh aspects, the method further comprises: sending a request to a host to release the first spare block associated with the first logical unit; and receiving a confirmation from the host, indicating the release of the first spare block of the SBs.
A seventeenth aspect of the disclosure provides a data storage device. The data storage device comprises: means for storing data in a nonvolatile memory comprising a plurality of logical units (LUs) and a plurality of spare blocks (SBs), each of the plurality of LUs being allocated with one or more of the plurality of SBs; means for determining usage information of at least a first logical unit and a second logical unit of the plurality of LUs; and means for allocating, based on the usage information, a first spare block of the plurality of SBs associated with the first logical unit to the second logical unit in response to a depletion of the one or more of the plurality of SBs allocated to the second logical unit.
An eighteenth aspect of the disclosure, alone or in combination with the seventeenth aspect, wherein the usage information comprises: memory utilization of the plurality of LUs; and memory availability of the plurality of LUs.
A nineteenth aspect of the disclosure, alone or in combination with the eighteen aspect, the data storage device further comprises: means for determining the memory utilization based on at least one of a write operation frequency or a speed of filling up of each LU of the plurality of LUs; and means for determining the memory availability based on an available amount of memory of each LU of the plurality of LUs.
A twentieth aspect of the disclosure, alone or in combination with any of the eighteenth and nineteenth aspects, the data storage device further comprises: means for determining a reallocation factor for each of the plurality of LUs, based on the memory utilization and the memory availability; and means for selecting, based on the reallocation factor, the first spare block to be reallocated from the first logical unit to the second logical unit as a spare block.
A twenty-first aspect of the disclosure, alone or in combination with any of the seventeenth, eighteenth, and nineteenth aspects, the data storage device further comprises means for determining that the first logical unit is less utilized among the plurality of LUS based on the usage information.
A twenty-second aspect of the disclosure, alone or in combination with any of the seventeenth, eighteenth, and nineteenth aspects, the data storage device further comprises: means for monitoring available memory in each LU of the plurality of LUs; and means for reallocating a spare block of the plurality of SBs from the first logical unit to the second logical unit, the first logical unit having more available memory among the plurality of LUs.
A twenty-third aspect of the disclosure, alone or in combination with any of the seventeenth, eighteenth, and nineteenth aspects, the data storage device further comprises: means for sending a request to a host to release the first spare block associated with the first logical unit; and means for receiving a confirmation from the host, indicating the release of the first spare block.
A twenty-fourth aspect of the disclosure provides a data storage system that comprises a host and a data storage device connected to the host. The data storage system comprises: a nonvolatile memory comprising a plurality of logical units (LUs) and a plurality of spare blocks (SBs), each of the plurality of LUs being allocated with one or more of the plurality of SBs; and a memory controller connected to the nonvolatile memory. The memory controller is configured to: store data from the host in the nonvolatile memory; determine usage information of at least a first logical unit and a second logical unit of the plurality of LUs; and allocate, based on the usage information, a first spare block of the plurality of SBs associated with the first logical unit to the second logical unit in response to a depletion of the one or more of the plurality of SBs allocated to the second logical unit.
A twenty-fifth aspect of the disclosure, alone or in combination with the twenty-fourth aspect, wherein the usage information comprises: memory utilization of the plurality of LUs; and memory availability of the plurality of LUs.
A twenty-sixth aspect of the disclosure, alone or in combination with the twenty-fifth aspect, wherein the memory controller is further configured to: determine the memory utilization based on at least one of a write operation frequency or a speed of filling up of each LU of the plurality of LUs; and determine the memory availability based on an available amount of memory of each LU of the plurality of LUs.
A twenty-seventh aspect of the disclosure, alone or in combination with any of the twenty-fifth and twenty-sixth aspects, wherein the memory controller is further configured to: determine a reallocation factor for each of the plurality of LUs, based on the memory utilization and the memory availability; and select, based on the reallocation factor, the first spare block to be reallocated from the first logical unit to the second logical unit as a spare block, wherein the reallocation factor of the first logical unit is greater than the reallocation factor of at least one other LU of the plurality of LUs.
A twenty-eighteenth aspect of the disclosure, alone or in combination with any of the twenty-fourth, twenty-fifth, and twenty-sixth aspects, wherein the memory controller is further configured to determine that the first logical unit is less utilized among the plurality of LUs based on the usage information.
A twenty-ninth aspect of the disclosure, alone or in combination with any of the twenty-fourth, twenty-fifth, and twenty-sixth aspects, wherein the memory controller is further configured to: monitor available memory in each LU of the plurality of LUs; and reallocate a spare block of the plurality of SBs from the first logical unit to the second logical unit, the first logical unit having more available memory among the plurality of LUs.
A thirtieth aspect of the disclosure, alone or in combination with any of the twenty-fourth, twenty-fifth, and twenty-sixth aspects, wherein the memory controller is further configured to: send a request to the host to release the first spare block associated with the first logical unit; and receive a confirmation from the host, indicating the release of the first spare block.

It is to be appreciated that the present disclosure is not limited to the exemplary terms used above to describe aspects of the present disclosure. For example, bandwidth may also be referred to as throughput, data rate, or another term.

Any reference to an element herein using a designation e.g., “first,” “second,” and so forth does not generally limit the quantity or order of those elements. Rather, these designations are used herein as a convenient way of distinguishing between two or more elements or instances of an element. Thus, a reference to first and second elements does not mean that only two elements can be employed, or that the first element must precede the second element.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The term “coupled” is used herein to refer to the direct or indirect electrical or other communicative coupling between two structures. Also, the term “approximately” means within ten percent of the stated value.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed is:

1. A data storage device, comprising:
a nonvolatile memory comprising a plurality of logical units (LUs) and a plurality of spare blocks (SBs), each of the plurality of LUs being allocated with one or more of the plurality of SBs; and
a memory controller configured to:
determine usage information of at least a first logical unit and a second logical unit of the plurality of LUs; and
allocate, based on the usage information, a first spare block of the plurality of SBs associated with the first logical unit to the second logical unit in response to a depletion of the one or more of the plurality of SBs allocated to the second logical unit.

2. The data storage device of claim 1, wherein the usage information comprises:
memory utilization of the plurality of LUs; and
memory availability of the plurality of LUs.

3. The data storage device of claim 2, wherein the memory controller is further configured to:
determine the memory utilization based on at least one of a write operation frequency or a speed of filling up of each LU of the plurality of LUs; and
determine the memory availability based on an available amount of memory of each LU of the plurality of LUs.

4. The data storage device of claim 2, wherein the memory controller is further configured to:
determine a reallocation factor for each of the plurality of LUs, based on the memory utilization and the memory availability; and
select, based on the reallocation factor, the first spare block to be reallocated from the first logical unit to the second logical unit as a spare block.

5. The data storage device of claim 4, wherein the reallocation factor of the first logical unit is greater than the reallocation factor of at least one other LU of the plurality of LUs.

6. The data storage device of claim 1, wherein the memory controller is further configured to:
determine that the first logical unit is less utilized among the plurality of LUs based on the usage information.

7. The data storage device of claim 1, wherein the memory controller is further configured to:
monitor available memory in each LU of the plurality of LUs; and
reallocate a spare block of the plurality of SBs from the first logical unit to the second logical unit, the first logical unit having more available memory among the plurality of LUs.

8. The data storage device of claim 1, wherein the memory controller is further configured to:
send a request to a host to release the first spare block associated with the first logical unit; and
receive a confirmation from the host, indicating the release of the first spare block.

9. A method of operating a data storage device, comprising:
determining usage information of at least a first logical unit and a second logical unit of a plurality of logical units (LUs), each of the plurality of LUs being allocated with one or more of a plurality of spare blocks (SBs); and
allocating, based on the usage information, a first spare block of the plurality of SBs associated with the first logical unit to the second logical unit in response to a depletion of the one or more of the plurality of SBs allocated to the second logical unit.

10. The method of claim 9, wherein the usage information comprises:
memory utilization of the plurality of LUs; and
memory availability of the plurality of LUs.

11. The method of claim 10, further comprising:
determining the memory utilization based on at least one of a write operation frequency or a speed of filling up of each LU of the plurality of LUs; and
determining the memory availability based on an available amount of memory of each LU of the plurality of LUs.

12. The method of claim 10, further comprising:
determining a reallocation factor for each of the plurality of LUs, based on the memory utilization and the memory availability; and
selecting, based on the reallocation factor, the first spare block to be reallocated from the first logical unit to the second logical unit as a spare block.

13. The method of claim 12, wherein the reallocation factor of the first logical unit is greater than the reallocation factor of at least one other LU of the plurality of LUs.

14. The method of claim 9, further comprising:
determining that the first logical unit is less utilized among the plurality of LUs based on the usage information.

15. The method of claim 9, further comprising:
monitoring available memory in each LU of the plurality of LUs; and
reallocating a spare block of the plurality of SBs from the first logical unit to the second logical unit, the first logical unit having more available memory among the plurality of LUs.

16. The method of claim 9, further comprising:
sending a request to a host to release the first spare block associated with the first logical unit; and
receiving a confirmation from the host, indicating the release of the first spare block of the plurality of SBs.

17. A data storage device, comprising:
means for storing data in a nonvolatile memory comprising a plurality of logical units (LUs) and a plurality of spare blocks (SBs), each of the plurality of LUs being allocated with one or more of the plurality of SBs;
means for determining usage information of at least a first logical unit and a second logical unit of the plurality of LUs; and
means for allocating, based on the usage information, a first spare block of the plurality of SBs associated with the first logical unit to the second logical unit in response to a depletion of the one or more of the plurality of SBs allocated to the second logical unit.

18. The data storage device of claim 17, wherein the usage information comprises:
memory utilization of the plurality of LUs; and
memory availability of the plurality of LUs.

19. The data storage device of claim 18, further comprising:
means for determining the memory utilization based on at least one of a write operation frequency or a speed of filling up of each LU of the plurality of LUs; and
means for determining the memory availability based on an available amount of memory of each LU of the plurality of LUs.

20. The data storage device of claim 18, further comprising:
means for determining a reallocation factor for each of the plurality of LUs, based on the memory utilization and the memory availability; and
means for selecting, based on the reallocation factor, the first spare block to be reallocated from the first logical unit to the second logical unit as a spare block.

21. The data storage device of claim 17, further comprising:
means for determining that the first logical unit is less utilized among the plurality of LUs based on the usage information.

22. The data storage device of claim 17, further comprising:
means for monitoring available memory in each LU of the plurality of LUs; and
means for reallocating a spare block of the plurality of SBs from the first logical unit to the second logical unit, the first logical unit having more available memory among the plurality of LUs.

23. The data storage device of claim 17, further comprising:
means for sending a request to a host to release the first spare block associated with the first logical unit; and
means for receiving a confirmation from the host, indicating the release of the first spare block.

24. A data storage system, comprising:
a host; and
a data storage device connected to the host, comprising:
a nonvolatile memory comprising a plurality of logical units (LUs) and a plurality of spare blocks (SBs), each of the plurality of LUs being allocated with one or more of the plurality of SBs; and
a memory controller connected to the nonvolatile memory, the memory controller configured to:
store data from the host in the nonvolatile memory;
determine usage information of at least a first logical unit and a second logical unit of the plurality of LUs; and
allocate, based on the usage information, a first spare block of the plurality of SBs associated with the first logical unit to the second logical unit in response to a depletion of the one or more of the plurality of SBs allocated to the second logical unit.

25. The data storage system of claim 24, wherein the usage information comprises:
memory utilization of the plurality of LUs; and
memory availability of the plurality of LUs.

26. The data storage system of claim 25, wherein the memory controller is further configured to:
determine the memory utilization based on at least one of a write operation frequency or a speed of filling up of each LU of the plurality of LUs; and
determine the memory availability based on an available amount of memory of each LU of the plurality of LUs.

27. The data storage system of claim 25, wherein the memory controller is further configured to:
determine a reallocation factor for each of the plurality of LUs, based on the memory utilization and the memory availability; and
select, based on the reallocation factor, the first spare block to be reallocated from the first logical unit to the second logical unit as a spare block, wherein the reallocation factor of the first logical unit is greater than the reallocation factor of at least one other LU of the plurality of LUs.

28. The data storage system of claim 24, wherein the memory controller is further configured to:
determine that the first logical unit is less utilized among the plurality of LUs based on the usage information.

29. The data storage system of claim 24, wherein the memory controller is further configured to:
monitor available memory in each LU of the plurality of LUs; and
reallocate a spare block of the plurality of SBs from the first logical unit to the second logical unit, the first logical unit having more available memory among the plurality of LUs.

30. The data storage system of claim 24, wherein the memory controller is further configured to:
send a request to the host to release the first spare block associated with the first logical unit; and
receive a confirmation from the host, indicating the release of the first spare block.
